(19) United States
(12) Patent Application Publication
(10) Pub. No.: US 2024/0190157 A1
(43) Pub. Date: Jun. 13, 2024

(54) PRE-ASSEMBLED STRUCTURE FOR FLEXOGRAPHIC PRINTING OF CORRUGATED CARDBOARD

(71) Applicant: Puntes Packaging Partners, S.L., Zaragoza (ES)

(72) Inventor: Carlos Redondo Gonzalez, Zaragoza (ES)

(21) Appl. No.: 18/538,222

(22) Filed: Dec. 13, 2023

(30) Foreign Application Priority Data
Dec. 13, 2022 (ES) U202232072

(51) Int. Cl. B41N 1/12; B41F 5/24

(52) U.S. Cl. CPC B41N 1/12; B41F 5/24

(57) ABSTRACT

The invention refers to a structure consisting of a set of pre-assembled elements on a polyester base used for the flexographic printing of corrugated cardboard, which is advantageously distinguished by the inclusion of adhesive foam directly between the printing plant and the polyester of the base to which the printing plate is fixed, which, among other advantages, improves the printed quality and reduces the pressure required for the cardboard to be covered by the ink with respect to conventional systems used until now for the same purpose.

### OBJECT OF THE INVENTION

The invention, as exposed on the wording of the present specification, refers to a pre-assembled structure for flexographic printing of corrugated cardboard which imparts to the function it is intended to, advantages and characteristics, which are described in detail below, which are an improvement of the current state of the art.

More specifically, the object of the invention focuses on a structure made up of a set of pre-assembled elements based on polyester that is used for flexographic printing of corrugated cardboard, which is advantageously distinguished by contemplating the inclusion of adhesive foam directly between the printing plant and the polyester of the base to which the printing plate is fixed, which, among other advantages, allows improving the printed quality and reducing the pressure that the cardboard needs to be covered by the ink compared to the conventional systems used until now for the same purpose.

### APPLICATION FIELD OF THE INVENTION

The application field of the present invention is framed within the sector of the industry dedicated to graphic printing, focusing particularly on the field of graphic printing of corrugated cardboard and more specifically flexography.

### BACKGROUND OF THE INVENTION

As is known, flexography is based on passing a sheet of cardboard or similar between two rollers, one of which contains a cliché with the relief of the printing, where the inks are water-based with very fast drying, so that the printing pace can also be fast and allows for a good quality/price ratio.

To this end, when the sheet or cardboard to be printed has an irregular surface, as is the case with corrugated board or corrugated cardboard, the cliché is made up of a pre-assembled structure consisting of a set of various layers, among which a photopolymer plate, which is engraved with the motif to be printed, and a support base that is mounted later that includes a layer of foam-type material, are contemplated.

The use of a foam base with a cushioning nature improves the results of the subsequent printing. When this is done on packaging or cardboard, where the surface is not completely flat, it is beneficial to use soft clichés with good adaptation. If the cliché is too hard, what can happen is that the fibre of the cardboard breaks, with consequent point deformations in the printing.

However, although the use of foam in said pre-assembled structures to soften the pressure on the end of the printing point and prevent the cardboard from breaking is known and widely spread, there are aspects that can be improved, being the objective of the present invention the development of a pre-assembled structure of this type that improves such aspects.

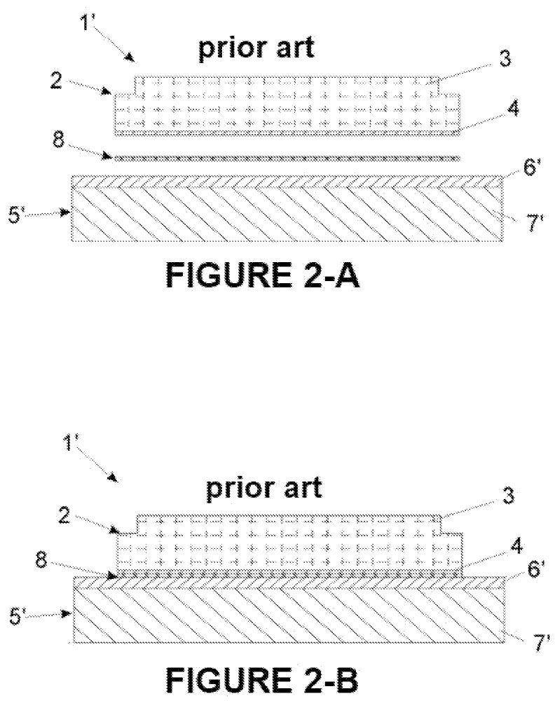

Specifically, in the conventional systems known until now, the foam layer of the support base, which is usually polyester, is incorporated at the bottom thereof, that is, without being in direct contact with the photopolymer plate, with which said layer of foam covers the entire extension of the base. Furthermore, to join all the layers, that is, to pre-assemble the base and printing plant assembly, what is done in the known systems is that an intermediate layer of rigid double-sided adhesive is incorporated between the polyester layer of the base and the photopolymer plate. An example of said type of conventional structure is seen in FIGS. 2-A and 2-B.

The objective of the present invention is, therefore, the development of an improved pre-assembled printing structure that provides advantages to said arrangement to improve, in turn, the efficiency in the result of the printing obtained, specifically to be able to eliminate the layer of rigid double-sided adhesive and to be able to reduce the surface of the foam to be used to that which corresponds exclusively to the printing surfaces of the photopolymer plate and not to the entire plate as occurs in known systems.

### Explanation of the Invention

The pre-assembled structure for flexographic printing of corrugated cardboard that the invention proposes represents an optimal solution to the objective described above which, at the same time, represents an improvement over what is currently known, the characterizing details that make it possible and that conveniently distinguish it being collected in the final claims that accompany this description.

What the invention proposes, as noted above, is a structure made up of a set of pre-assembled elements based on polyester that is used for flexographic printing of corrugated cardboard, which is advantageously distinguished by comprising an adhesive foam layer incorporated directly between the printing plant and the polyester of the base to which the printing plate is fixed, which provides a series of advantages over conventional systems used until now for the same purpose.

More specifically, pre-assembled structures for conventional flexographic printing are essentially formed by a lower support base which, in turn, is composed of a layer of polyester on the surface or upper face and a layer of padded foam adhered on its lower face, an upper photopolymer plate which, in turn, is composed of an upper layer of photopolymer engraved with the motif to be printed and a lower layer of polyester, and, in addition, an intermediate sheet of rigid adhesive to which the support base is fixed at the bottom and the photopolymer plate at the top so that it serves as a union between both things.

And, unlike this, the pre-assembled structure for flexographic printing of corrugated cardboard object of the invention, also comprising a lower polyester support base and an upper photopolymer plate formed by an upper layer of photopolymer engraved with the motif to be printed and a lower polyester layer, it is essentially distinguished by the fact that the lower support base is a polyester sheet without padded foam and on said base it is fixed to the lower polyester layer of the photopolymer plate by means of padded foam which is adhesive on both sides.

With this, the advantages provided by the pre-assembled structure object of the invention, by modifying the situation of the padded foam from the lower to the upper face of the polyester sheet of the support base, are several:
Firstly, the printing quality is improved, since the cushioning effect of the foam acts directly on the photopolymer and not through the rigid polyester sheet, eliminating the so-called “flutting” or rolling effect of the base which is produced in conventional systems with the foam underneath.
Secondly, it allows a reduction in the crushing of the corrugated cardboard, by cushioning the pressure exerted on the cardboard in the printing process, which, in turn, allows the foam to absorb the waves derived from the printing in a more efficient way.
In addition, it allows a reduction in the amount of padded foam to be used in each job, estimated between 20-30%, since that in the conventional system it is necessary to use as much foam as there is pre-assembly surface, while in the structure object of the invention, only that corresponding to the printing surfaces can be used.
Likewise, the inclusion of the layer of two-sided rigid adhesive commonly used is eliminated, as the foam sheet itself includes the adhesive.
Finally, a reduction in the carbon footprint estimated at 20-30% is achieved by reducing the amount of foam and adhesive used.

### DESCRIPTION OF THE DRAWINGS

In order to complement the description being made and to ease a better understanding of the characteristics of the invention, is attached to the present specification, making part of the same, a set of layouts where, with an illustrative non limitative character, the following has been represented:

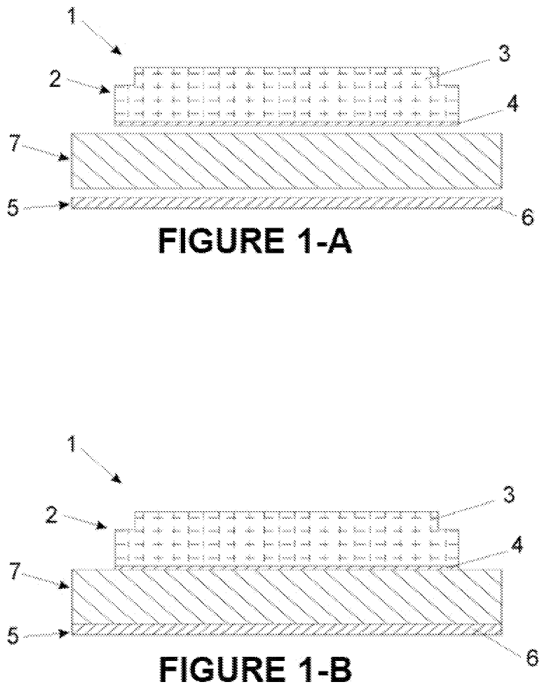

Figures number 1-A and 1-B.— Show a schematic sectional view of an example of embodiment of the pre-assembled structure for flexographic printing of corrugated cardboard object of the invention, represented respectively in exploded view (FIG. 1-A) and once assembled (FIG. 1-B), the different layers and elements it comprises as well as the arrangement thereof being appreciated.

And figures number 2-A and 2-B.— Show a schematic sectional view of an example of a pre-assembled structure for flexographic printing of corrugated cardboard, according to the prior art, also represented in an exploded view and once assembled, the layers and elements it comprises, and the arrangement thereof being appreciated.

### PREFERRED EMBODIMENT OF THE INVENTION

In view of the aforementioned figures, and in accordance with the numbering adopted, one can see in them an example of a structure according to the prior art and an example of a non-limiting embodiment of the pre-assembled structure for flexographic printing of corrugated cardboard of the invention, which comprises what is indicated and described in detail below.

Thus, as can be seen in FIGS. 1-A and 1-B, the structure (1) of the invention, applicable once pre-assembled for flexographic printing of corrugated cardboard, comprises in a known manner:
a photopolymer plate (2) on which the motif to be printed is engraved, in turn formed by a layer of photopolymer (3) incorporated on a first polyester sheet (4);
a support base (5) that is fixed adhesively to the plate (2) and which, in turn, comprises a second polyester sheet (6); and
a padded foam (7).

And, from said already known configuration, the structure (1) of the invention is essentially distinguished in that the padded foam (7) is not part of the support base (5) but is an independent element and is incorporated sandwiched between the first polyester sheet (4) of the photopolymer plate (2) and the polyester sheet (6) of the support base (5), in such a way that said foam (7) is directly in contact with said photopolymer plate (2).

Furthermore, in the preferred embodiment of the structure (1) of the invention, the padded foam (7) is a sheet that incorporates adhesive on both sides, acting as the joining means that fixes the support base (5) to the photopolymer plate (2).

In any case, the foam (7), although it can cover the entire extension of the polyester sheet (6) of the support base (5), optionally covers only the extension of the engraved areas of the photopolymer plate (2).

Finally, the foam (7) has variable thickness (g) and density, depending on the needs of each case.

For its part, taking into account FIGS. 2-A and 2-B, it is observed how, unlike the above, the structures of the type concerned here, according to the prior art, referenced in this case as (1′), comprise:
a photopolymer plate (2) on which the motif to be printed is engraved, in turn formed by a layer of photopolymer (3) incorporated on a first polyester sheet (4);
a support base (5′) which, in turn, comprises a second polyester sheet (6′), and a padded foam sheet (7′) incorporated on the opposite side of the polyester sheet (6) so that it is not in direct contact with the photopolymer plate (2) and covering the entire extension of the base (5′); and
a layer of rigid adhesive (8) with which the polyester sheet (6) of the support base (5′) is fixed to the polyester sheet (4) of the photopolymer plate (2).

Having sufficiently described the nature of the present invention, as well as a way of putting it into practice, it is not considered necessary to make a more extensive explanation in order that any person skilled in the art will understand its scope and the advantages derived from it, making known that, within reason it could be put into practice in other embodiments differing in detail from that indicated by way of example, and which will obtain the degree of protection that is sought, provided that its fundamental principle is not altered, changed or modified.

1. Pre-assembled structure for flexographic printing of corrugated cardboard which, by comprising: a photopolymer plate (2) on which the motif to be printed is engraved, formed in turn by a layer of photopolymer (3) incorporated on a first polyester sheet (4); a support base (5) that is fixed adhesively to the plate (2) and which, in turn, comprises a second polyester sheet (6); and a padded foam (7), is characterized by the fact that the padded foam (7), which is not part of the support base (5) but is an independent element, is incorporated sandwiched between the first polyester sheet (4) of the photopolymer plate (2) and the polyester sheet (6) of the support base (5), such that said foam (7) is directly in contact with said photopolymer plate (2).

2. Pre-assembled structure for flexographic printing of corrugated cardboard, according to claim 1, characterized in that the padded foam (7) is a sheet that incorporates adhesive on both sides, acting as the joining means that fixes the base of support (5) to the photopolymer plate (2).

3. Pre-assembled structure for flexographic printing of corrugated cardboard, according to claim 1, characterized in that the foam (7) covers the entire extension of the polyester sheet (6) of the support base (5).

4. Pre-assembled structure for flexographic printing of corrugated cardboard, according to claim 2, characterized in that the foam (7) covers the entire extension of the polyester sheet (6) of the support base (5).

5. Pre-assembled structure for flexographic printing of corrugated cardboard, according to claim 1, characterized in that the foam (7) covers only the extension of the engraved areas of the photopolymer plate (2).

6. Pre-assembled structure for flexographic printing of corrugated cardboard, according to claim 2, characterized in that the foam (7) covers only the extension of the engraved areas of the photopolymer plate (2).

7. Pre-assembled structure for flexographic printing of corrugated cardboard, according to claim 1, characterized in that the foam (7) has variable thickness (g) and density, depending on the needs of each case.

8. Pre-assembled structure for flexographic printing of corrugated cardboard, according to claim 2, characterized in that the foam (7) has variable thickness (g) and density, depending on the needs of each case.

9. Pre-assembled structure for flexographic printing of corrugated cardboard, according to claim 4, characterized in that the foam (7) has variable thickness (g) and density, depending on the needs of each case.

10. Pre-assembled structure for flexographic printing of corrugated cardboard, according to claim 6, characterized in that the foam (7) has variable thickness (g) and density, depending on the needs of each case.
